(19) United States
(12) Patent Application Publication
(10) Pub. No.: US 2010/0072293 A1
(43) Pub. Date: Mar. 25, 2010

(54) STEAM CONTROL SYSTEM

(76) Inventors: Bernard Flynn, Dix Hills, NY (US); James P. Flynn, Smithtown, NY (US)

Correspondence Address: ADVANTIA LAW GROUP, 9035 SOUTH 1300 EAST, SUITE 200, SANDY, UT, 84094, US

(21) Appl. No.: 12/627,150

(22) Filed: Nov. 30, 2009

Related U.S. Application Data
(63) Continuation-in-part of application No. 11/945,344, filed on Nov. 27, 2007.

(51) Int. Cl. F24D 19/10; G05D 23/19

(52) U.S. Cl. 237/9 R; 700/300

(57) ABSTRACT

A steam control system. An illustrative embodiment of the steam control system includes a boiler, a steam outlet conduit communicating with the boiler, a steam control valve provided in the steam outlet conduit, a controller connected to the steam control valve and an outdoor temperature sensor connected to the controller.

### CROSS-REFERENCE TO RELATED APPLICATIONS

This application is a Continuation-in-Part application of, under 35 U.S.C. §121, and claims priority to, under 35 U.S.C. §121, U.S. Non-Provisional application Ser. No. 11/945,344, entitled Steam Control System, by Flynn et al., filed on Nov. 27, 2007; which is incorporated by reference herein in its entirety.

### BACKGROUND OF THE INVENTION

1. Field of the Invention

The present invention relates to steam control systems, specifically to a steam control system for steam heating systems having multiple sensors.

2. Description of the Related Art

Steam heating systems are used is come types of commercial and multi-unit residential structures. A typical steam heating system includes a boiler from which steam is distributed to multiple steam radiators located throughout a building. A temperature control system for the steam heating system may include only one type of sensor input, such as the temperature of the interior of the building. Some improvements have been made in the field. Examples of references related to the present invention are described below, and the supported teachings of each reference are incorporated by reference herein:

U.S. Pat. No. 4,371,111, issued to Pernosky, discloses a heating system including a hot water heater and an air duct distribution system employs a housing having a heat exchanger located within its interior in association with a blower. Water conduits lead between the heat exchanger and the hot water outlet and the cold water inlet of the water heater. Water is passed from the hot water outlet of the water heater to the heat exchanger through a water conduit and then returned to a second conduit which passes through a pump to the cold water inlet of the water heater. The pump forcibly moves the water through the above circuit. Heat is exchanged from hot water flowing through the heat exchanger to air which is passed through the heat exchanger by a blower. After being heated the air is forced into the air duct for distribution. The system can be augmented with a second heat exchanger placed in the flue of the water heater. This second heat exchanger forms a part of the conduit between the hot water outlet of this water heater and the heat exchanger and extracts waste heat from the flue of the water heater prior to flow of the hot water to the heat exchanger.

U.S. Pat. No. 4,178,907, issued to Sweat Jr., discloses a water heating and forced air heating system that provides potable hot water and that also provides heated air for heating enclosed spaces within buildings, including: a water heater including a water tank filled with water, a burner for heating the water in the tank, and an exhaust flue for removing hot gases generated by the burner; a gas-to-liquid heat exchange unit disposed within the flue; a forced air heater having a casing that defines a chamber, a liquid-to-gas heat exchange unit disposed within the chamber, a gas-to-gas heat exchange unit also disposed within the chamber, and a blower for pulling fresh air into the chamber and blowing it past the heat exchange units to absorb heat; a pump for pumping water through the gas-to-liquid heat exchange unit so that the water becomes heated by the hot gases within the flue; another pump for pumping heated water through the liquid-to-gas heat exchange unit to heat the air flowing within the chamber; and a conduit for connecting the terminal end of the flue to the gas-to-gas heat exchange unit in order to further heat the air flowing through the chamber.

U.S. Pat. No. 4,274,477, issued to Nikolic, discloses a radiator for low-pressure steam heating systems comprises at least two chambers, which constitute respective radiator elements. Consecutive elements are interconnected in an upper portion and in a lower portion. The upper portion of each element is connected to a low-pressure steam source. The lower portion of each element is connected to a condensate trap. At least individual ones of the elements are adapted to be shut off from the steam supply.

U.S. Pat. No. 4,545,524, issued to Zelczer, discloses a zone control apparatus for central heating and/or cooling systems having a central fluid heating and/or cooling plant and conduits for directing the heated or cooled fluid to the rooms in a house or other building being serviced by the system. The zone control apparatus comprises one or more flow control devices operatively associated with respective fluid conduits in the central heating and/or cooling system, and a cycle controller for cycling the flow control device or devices between high and low (or no) flow conditions at times strategically selected to correspond to periods of high and low use of the room or rooms with which the flow control devices are respectively associated. Accordingly, the apparatus operates automatically to eliminate unnecessary heating or cooling of individual rooms or zones during cyclical periods of low or no use whereby substantial energy savings and other benefits may be obtained with minimal compromise in comfort. In particular, the zone control apparatus may operate on the system to isolate or separate daytime and nighttime use areas or zones of the house for selective heating or cooling only during their respective daytime or nighttime use or anticipated use periods. Moreover, the zone control apparatus may be easily installed in existing systems as a retrofit or in new installations.

The inventions heretofore known suffer from a number of disadvantages which include being limited in application, being limited in versatility, being limited in use, being inefficient, being expensive, being difficult to control, and being limited in adaptability.

What is needed is a steam control system that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available steam control system. Accordingly, the present invention has been developed to provide an efficient and effective steam control system.

According to one embodiment of the invention, there is a steam control system which may include a boiler. The steam control system may include a steam outlet conduit communicating with the boiler. The steam control system may also include a steam control valve provided in the steam outlet conduit. In addition, the steam control system may include a controller connected to the steam control valve. The steam control system may also include an outdoor temperature sensor connected to the controller. The steam control system may also include at least one room temperature sensor connected to the controller. The steam control system may include a steam temperature sensor communicating with said steam outlet conduit and connected to the controller. Furthermore, the steam control system may include a vacuum sensor communicating with said steam outlet conduit and connected to the controller. The steam control system may also include a vacuum sensor line connecting said vacuum sensor to the controller and a condensation return line connecting the vacuum sensor line to the boiler. The steam control system may include a condensation return vacuum pump provided in the condensation return line and a vacuum pressure sensor provided in the condensation return line between the vacuum sensor line and the condensation return vacuum pump and connected to the controller. The steam control system may include a variable frequency drive connected to the controller.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a schematic diagram of a steam control system, according to one embodiment of the invention; and

FIG. 2 is a block diagram of a steam control system according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

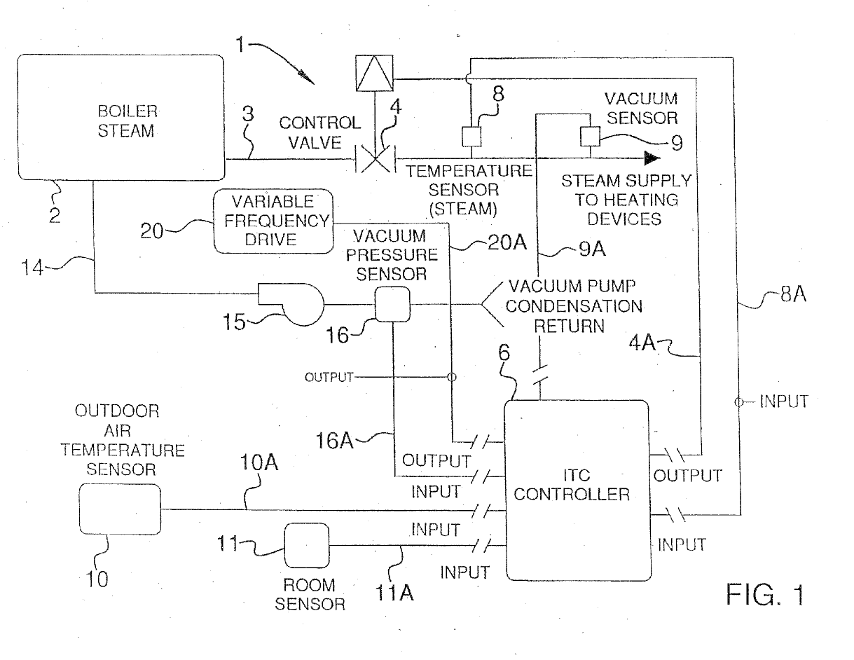

Referring to FIG. 1 of the drawing, an illustrative embodiment of the steam control system is generally indicated by reference numeral 1. The steam control system 1 includes a boiler 2 which receives a supply of water (not shown) and generates steam (not shown). The boiler 2 may be conventional.

A steam outlet conduit 3 extends from the boiler 2. A steam control valve 4 is provided in the steam outlet conduit 3 to vary the volume of steam which is distributed from the boiler 2 and through the steam outlet conduit 3, as will be hereinafter described. Heating devices (not shown) such as radiators which can be used to heat rooms in a commercial or multi-unit residential structure, for example, are connected to the steam outlet conduit 3. Other types of devices which utilize steam may be connected to the steam outlet conduit 3, depending on the application.

A controller 6 is connected to the control valve 4 such as through a valve control line 4a, for example. As will be hereinafter described, the controller 6 is adapted to control opening and closing of the control valve 4 and thus, the volume of steam which is distributed through the steam outlet conduit 3, based on input from multiple input sensors. The input sensors may include, for example, a steam temperature sensor 8 which is adapted to sense the temperature of the steam flowing through the steam outlet conduit 3. The steam temperature sensor 8 may be connected to the controller 6 via a steam temperature sensor line 8a. A vacuum sensor 9 may be provided in the steam outlet conduit 3 and adapted to sense a vacuum pressure in the steam outlet conduit 3. The vacuum sensor 9 may be connected to the controller 6 via a vacuum sensor line 9a. An outdoor air temperature sensor 10 may be connected to the controller 6 via an outdoor temperature sensor line 10a. The outdoor air temperature sensor 10 is adapted to sense the temperature outside a commercial or residential structure in which the steam control system 1 is installed. At least one room temperature sensor 11 may be connected to the controller 6 via a room temperature sensor line 11a. The at least one room temperature sensor 11 is adapted to sense the temperature of at least one room in the commercial or residential structure in which the steam control system 1 is installed. Multiple temperature sensors 11 may be connected to the controller 6 to sense the temperature of multiple rooms in the commercial or residential structure.

A condensation return line 14 may connect the vacuum sensor line 9a to the boiler 2. A condensation return vacuum pump 15 may be provided in the condensation return line 14 to pump condensation from the vacuum sensor line 9a, through the condensation return line 14 and to the boiler 2. A vacuum pressure sensor 16 may be provided in the condensation return line 14 between the vacuum sensor line 9a and the condensation return vacuum pump 15. The vacuum pressure sensor 16 may be connected to the controller 0 via a sensor line 16a. Accordingly, responsive to input from the vacuum pressure sensor 16 to the controller 6, the condensation return vacuum pump 15 is operated to maintain vacuum pressure in the condensation return line 14 and ensure the continual removal of condensation from the vacuum sensor line 9a. A variable frequency drive 20 for an AC electric motor (not shown) may be connected to the controller 6 through a drive line 20a.

In typical operation of the steam control system 1, steam (not shown) is generated in the boiler 2. Responsive to input from the steam temperature sensor 8, the vacuum sensor 9, the outdoor air temperature sensor 10 and the room temperature sensor 11, the controller 6 adjusts the steam control valve 4 to facilitate flow of a controlled volume of steam from the boiler 2, through the steam outlet conduit 3 and to the heating devices (not shown) and/or other types of devices (not shown) which utilize steam. The controlled volume of steam which flows through the steam outlet conduit 3 depends on the temperature of the steam (as determined by the steam temperature sensor 8); the vacuum pressure in the steam outlet conduit 3 (as determined by the vacuum sensor 9); the outdoor temperature (as determined by the outdoor temperature sensor 10); and the room temperature (as determined by the at least one room temperature sensor 11). Generally, the controller 3 opens steam control valve 4 to a relatively wider configuration to facilitate flow of a relatively large volume of steam through the steam outlet conduit 3 when the temperature of the steam, the vacuum pressure in the steam outlet conduit 3, the outdoor temperature and/or the room temperature is low. Conversely, controller 3 partially closes the steam control valve 4 to facilitate flow of a relatively smaller volume of steam through the steam outlet conduit 3 when the temperature of the steam, the vacuum pressure in the steam outlet conduit 3, the outdoor temperature and/or the room temperature is high. In the foregoing manner, the controller 3 facilitates enhanced interior temperature control of the commercial or residential establishment. Condensation may be removed from the vacuum sensor line 9a and returned to the boiler 2 by operation of the condensation return vacuum pump 15, as was heretofore described,

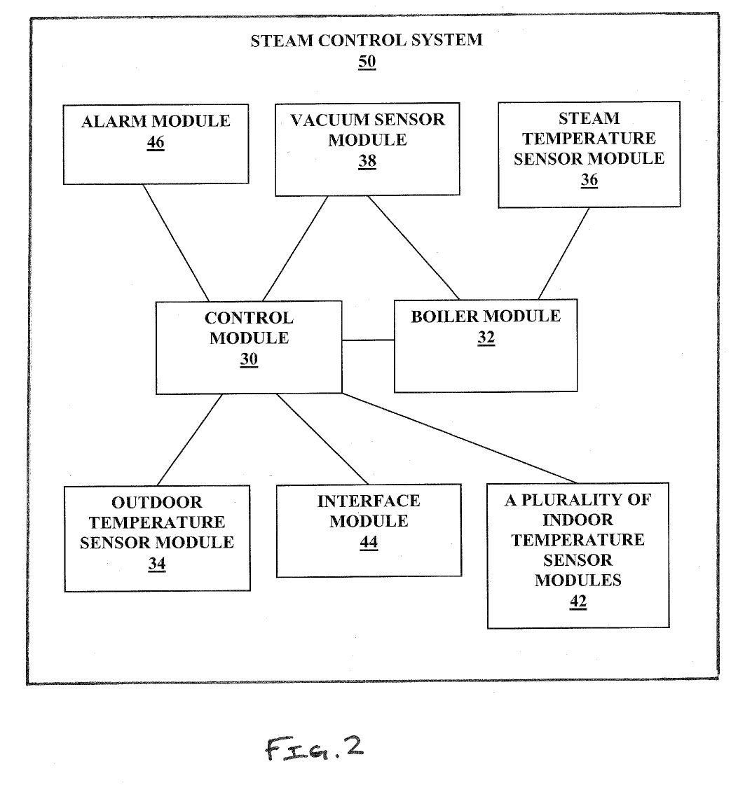

FIG. 2 illustrates a steam control system, according to one embodiment of the invention, configured to selectably control a steam heating system in a building. The illustrated steam control system 50 includes a control module 30 configured to manage and operate other modules and components of the steam control system 50. The steam control system 50 includes a boiler module 32, in communication with the control module 30, configured to produce steam for heating a building according to instructions from the control module and/or other modules. The steam control system 50 also includes an outdoor temperature sensor module 34, in communication with the control module 30 and configured to sense an outdoor temperature of a building. The steam control system 50 includes a steam temperature sensor module 36 in communication with the control module 30 and the boiler module 32, configured to sense a steam temperature of the boiler module 32.

In addition, the steam control system 50 includes a vacuum sensor module 38, in communication with the control module 30 and the boiler module 32, configured to control a vacuum differential of the boiler module 32. The vacuum sensor module 38 is configured to sense a vacuum pressure of the boiler module 32. The steam control system 10 also includes a plurality of indoor temperature sensor modules 42 in communication with the control module 30 and configured to sense a temperature of a room of a building. Furthermore, the steam control system 10 includes an interface module 44 in communication with the control module 30 and the plurality of indoor temperature sensor modules 42, configured to adjust a desired temperature of a room of a building. The steam control system 10 also includes an alarm module 46 in communication with the control module 30 and configured to provide an alarm when any of the outdoor temperature, indoor temperature, steam temperature, the vacuum differential, or the vacuum pressure, exceed a predetermined limit. The control module 30 is configured to include a temperature schedule; the temperature schedule is used by the control module to determine appropriate signals to send to other modules in response to detected conditions. The following is a non-limiting example of a temperature schedule of a control module of a steam control system:

| OUTSIDE AIR | STEAM SUPPLY | SUPPLY/RETURN VACUUM |
|---|---|---|
| TEMP | TEMP | DIFFERENTIAL |
| 60° F. | 170° F. | 2 INCHES |
| 30° F. | 185° F. | 4 INCHES |
| 10° F. | 200° F. | 8 INCHES |

In operation of one embodiment of the invention, there is a steam control system configured to provide steam heat to a building. A user programs a temperature schedule for a steam control system to control the temperature of a building. The control module is initialized with a temperature schedule that determines what vacuum will be held in the system according to the outside air temperatures detected.

The building is steam heated with a boiler module. The user may adjust the temperature of each room using the interface module. The interface module adjusts the temperature according to the temperature of the room from the indoor temperature sensor module. The control module adjusts the pressure within the steam system according to the outdoor temperature measurements and the temperature schedule. The control module then receives steam temperature data within the system to confirm that the appropriate steam temperature is achieved by the pressure adjustments.

The control module follows the temperature schedule to maintain the steam temperature and vacuum pressure of the system in response to the outdoor temperature and indoor temperature levels. The alarm module is configured to send an alarm to an operator when any measured characteristic of the system falls out of a predetermined range or schedule.

The control module may be configured to adjust a temperature schedule according to a predefined protocol, programming, or algorithm. Such may take into account information from any of the sensor modules described herein alone, in combination, or in combination with other modules such as but not limited to a timing module or a season schedule.

As a non-limiting example, room temperature data from a room of a building outfitted with such a system may indicate that a room is heating up too quickly or too slowly when the outside temperature is at or near 60 degrees F. Accordingly, the control module may adjust the vacuum differential entry associated with the 60 degree F. record up or down as required to improve the heating performance for the room. The steam supply temperature entry for that same record may be calculated according to known thermodynamic relationships between pressure and temperature for steam. The control module may reinitialize itself with the newly revised schedule and operate therewith accordingly. The control module may utilize numerical approximation methods known in the art to predict, measure, and/or establish patterns of knowledge that may enable the control module to make “smart” adjustments and to improve its ability to adjust schedules to be appropriate to the needs and desires of occupants of the building.

Advantageously, the steam control system reduces energy consumption for steam heated buildings. This is accomplished without having a substantial adverse impact on the heating performance of such systems and therefore represents a substantial improvement over existing systems that results in savings for building operators. These savings are most apparent in climates where the outside temperatures range within the limits of a temperature schedule wherein a pressure differential is indicated because the boiler and other systems need not operate at full capacity in order to properly heat the building.

Although this disclosure has been described with respect to certain exemplary embodiments, it is to be understood that the specific embodiments are for purposes of illustration and not limitation, as other variations will occur to those of ordinary skill in the art.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate specific connections and relationships between operating units (devices, and etc.) and modules of the system it is understood that other connections may be present and that variations on such connections may exist in various embodiments of the invention. Further, unspecified operating units and/or modules may also be present and may facilitate operation of the system.

Additionally, although the figures illustrate a single system in operation, it is understood that there may be multiple systems serving a single building and/or multiple buildings served by a single system.

It is also envisioned that one or more modules and/or operating units may include manual controls.

It is expected that there could be numerous variations of the design of this invention.

Finally, it is envisioned that the components of the device may be constructed of a variety of materials.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A steam control system, comprising:
a boiler;
a steam outlet conduit communicating with said boiler;
a steam control valve provided in said steam outlet conduit;
a controller connected to said steam control valve; and
an outdoor temperature sensor connected to said controller.

2. The steam control system of claim 1 further comprising at least one room temperature sensor connected to said controller.

3. The steam control system of claim 1 further comprising a steam temperature sensor communicating with said steam outlet conduit and connected to said controller.

4. The steam control system of claim 1 further comprising a vacuum sensor communicating with said steam outlet conduit and connected to said controller.

5. The steam control system of claim 4 further comprising a vacuum sensor line connecting said vacuum sensor to said controller and a condensation return line connecting said vacuum sensor line to said boiler.

6. The steam control system of claim 5 further comprising a condensation return vacuum pump provided in said condensation return line and a vacuum pressure sensor provided in said condensation return line between said vacuum sensor line and said condensation return vacuum pump and connected to said controller.

7. The steam control system of claim 1 further comprising a variable frequency drive connected to said controller.

8. A steam control system, comprising:
a boiler;
a steam outlet conduit communicating with said boiler;
a steam control valve provided in said steam outlet conduit;
a controller connected to said steam control valve;
an outdoor temperature sensor connected to said controller;
at least one room temperature sensor connected to said controller;
a steam temperature sensor communicating with said steam outlet conduit and connected to said controller; and
a vacuum sensor communicating with said steam outlet conduit and connected to said controller.

9. The steam control system of claim 8 further comprising a vacuum sensor line connecting said vacuum sensor to said controller and a condensation return line connecting said vacuum sensor line to said boiler.

10. The steam control system of claim 9 further comprising a condensation return vacuum pump provided in said condensation return line and a vacuum pressure sensor provided in said condensation return line between said vacuum sensor line and said condensation return vacuum pump and connected to said controller.

11. The steam control system of claim 8 further comprising a variable frequency drive connected to said controller.

12. A steam control system configured to selectably control a steam system, comprising:
a) a control module configured to selectably control a temperature of a building;
b) a boiler module in communication with the control module and configured to provide steam heat to a building;
c) an outdoor temperature sensor module in communication with the control module and configured to provide outdoor temperature measurements of a building;
d) a steam temperature sensor module, in communication with the control module and the boiler module, configured to sense a temperature of the steam heat from the boiler module;
e) a vacuum sensor module in communication with the control module and the boiler module and configured to control a vacuum pump of the boiler module;
f) a vacuum pressure sensor module in communication with the control module, the vacuum pressure sensor module and the boiler module, configured to control vacuum pressure of the boiler module;
g) a plurality of indoor temperature sensor modules in communication with the control module and configured to sense a temperature of a room of a building;
h) an interface module in communication with the control module and configured to provide interface controls to a room of a building; and
i) an alarm module in communication with the interface module and configured to provide an audible alarm when the temperature exceeds a predetermined threshold.
